(19) United States
(12) Patent Application Publication
(10) Pub. No.: US 2008/0253746 A1
(43) Pub. Date: Oct. 16, 2008

(54) Storage Capacity Configuration

(75) Inventor: Karl J. Wood, Crawley (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,606

(22) PCT Filed: Feb. 1, 2005
(86) PCT No.: PCT/IB2005/050422

§ 371 Date: Aug. 1, 2006

(30) Foreign Application Priority Data
Feb. 3, 2004 (GB) 0402273.7

(51) Int. Cl. H04N 7/26

(52) U.S. Cl. 386/124; 386/E05.001

(57) ABSTRACT

A method for configuring the storage capacity of a recording apparatus. An AV content item is recorded (104) preferably on a random access media, for example a hard disk based personal video recorder. It is then reproduced (106) for review by a user, possibly contemporaneously with the recording. During reproduction, the content and/or metadata associated with the content is analysed (108) to identify a pre-determined condition. Where a condition occurs (110), the user is prompted (112) for a response. The storage capacity used for storing the content item is then configured (116) according to the user response, including the case where no user response is provided.

The present invention relates to a method and apparatus for storing AV content items; in particular, the configuration of finite storage capacity used for storing AV content items.

Personal Video Recorders (PVRs, also known as Digital Video Recorders, DVRs) have compelling features such as instant record and random access retrieval of an item for replay. Even though storage (e.g. hard disk) capacity of such recorders offer perhaps 30 or more hours, strategies need to be deployed to manage this finite capacity, in particular to determine when and which recorded items to delete (erase) from storage. In an Is embodiment from TiVo Inc. of Alviso, Calif., USA (“Viewers' Guide for the Tivo Recorder”, document SDOC-00029-001 Rev. B, at p 18), a Now Playing list comprises those programmes that have been recorded (and therefore occupy capacity); each programme being normally saved for two days after which it may be automatically deleted. A disadvantage is that such deletion does not take into account whether or not the item has actually been viewed. In an embodiment from British Sky Broadcasting Ltd of London, UK (“Sky+ User Guide” Version 4.1, August 2003, at p 70), a user may choose a disk space management mode wherein recorded programmes will be deleted automatically when there is insufficient space to record new programmes. The strategy used for deletion being that recorded programmes previously watched will first be deleted, followed by recorded programmes that have not been watched. As with the TiVo embodiment, a disadvantage is that a non-viewed item may be deleted. Furthermore, for both embodiments the decision to delete a particular programme from storage is generally deferred until there is a shortage of capacity to record a further programme. When this situation is reached, the management of the storage capacity to make capacity available for recording further programmes becomes less optimal than where capacity is already available. In the above embodiments, for a given capacity such a situation could occur earlier than would be the case where the decision to delete a particular programme was not deferred. Clearly, this issue is especially acute where there is relatively modest total storage capacity (such as for removable media) or where many further programmes need to be recorded.

In a further aspect, known embodiments (including TiVo and Sky+ embodiments described above) utilise manual deletion of a recorded item by means of user selection from a list of recorded items. Although this allows deletion before capacity becomes insufficient for new recordings, a disadvantage is that an item may not be familiar to the user, resulting in a likelihood that the user will procrastinate and decide not to delete the item to avoid the risk of deleting something potentially worth viewing. Alternatively, a typical user may defer such deletions until the point where it is imperative, that is, when capacity for new items becomes insufficient. Such last moment capacity management methods are likely to result in maintaining known disadvantages familiar to the user of a traditional VHS recorder, for example stress due to time pressure in deciding which item(s) to delete combined with risk of deleting a ‘wanted item’ in order to make room for a new item to be recorded. Furthermore, present methods do not fully exploit the capability of the disk filing system to assign and modify attributes of a recorded content item. A disk or other storage means which maintains in storage unwanted content items limits the capacity available for temporarily buffering (that is, speculatively storing) or scheduling the recording of further content items, for example those received via broadcast TV channels.

It is an object of the present invention to improve over the known art.

In accordance with the present invention there is provided a method for configuring the storage capacity of a recording apparatus used for storing at least one AV content item, the method comprising:
storing a content item;
reproducing the stored content item for review by a user;
while reproducing the stored content item, analysing the reproduction of the content item to identify the occurrence of a pre-determined condition;
where a pre-determined condition occurs, prompting the user for a response; and
configuring the storage capacity used for storing the content item according to the user response.

The present invention comes from a realisation that storage capacity configuration of a recording apparatus is best performed as part of the normal reviewing process, rather than being performed as a dedicated housekeeping task. As a result, the user is better placed to make a decision for example to delete or archive a content item having reviewed the item. Advantageously, during reviewing the user is prompted for a response which will enable the storage capacity used for storing the content item to be configured according to the user response. Preferably, for a content item comprising video the prompt is rendered on the same display as the item. In one example, the prompt occurs at the end of the item in that the reviewer is then sufficiently familiar with the item to decide whether to archive or delete it. In a second example, the user is prompted when both the start and end of the content item have been identified so as to prompt the user once it is inferred that he/she has reviewed the entire item. For both examples, a fast and accurate detection of the end of an item is desirable, such as by detecting the credits at the end of a video content item using known techniques. This ensures the user is prompted before he/she attempts to start another activity (that is, change context) such as make a refreshment, surf other TV channels, or the like. Other conditions to trigger suitable prompts can be readily identified by the skilled person.

The method is particularly suited to embodiment in PVRs due to the ease of configuring their storage capacity, for example when deleting a previously stored item. Such apparatus has the ability to ‘speculatively record’ whereby a user can record for example a broadcast TV show and contemporaneously view the recording. Advantageously, the method also allows such recordings to be maintained in the event that a user does not respond to a prompt, for example the viewer is asleep when prompted at the end of the show. Suitable metadata embedded within, or provided in relation to, an item by the content provider (for example, a broadcaster) can assist the operation of the method. However, for many purposes it is preferred to have an accurate detection of the end of a content item, as exemplified by the ‘credits detection’ example discussed above. In a preferred embodiment, where a user does not respond to a prompt the associated recording may be maintained for a limited time period, after which the recording might be marked for automatic deletion.

As a further advantage, the method supports the situation where a user rents a content item, for example a movie on DVD or Pay-per-view. While watching the movie, the movie is also recorded on a speculative basis and for some reason the user fails to respond to a prompt, for example at the end of the movie. In turn, the stored item may be watched again within a limited time period, as with speculative recordings above. Alternatively, reproduction of the stored item may be conditional on an authorisation, for example notifying a service provider of the existence of the speculative recording and receiving in return an authorisation to enable reproduction, perhaps in exchange for a supplementary payment. Automated methods to perform such functions are well known to the skilled person and will not be further discussed herein. Furthermore, a speculative recording might also be protected from unauthorised copying, again using a suitable method known to the skilled person; the authorisation and copy protection functions may be combined in a single method.

In the case where a user when prompted decides to delete a stored content item, the storage capacity used for storing the content item may then be configured to be released. Advantageously, the decision to delete the content item is not deferred, for example until there is a shortage of capacity. The storage capacity used for storing an item might be released immediately; preferably, the capacity is marked as available thereby advantageously permitting restoration of the stored content item should the user change his/her mind. Alternatively, the storage capacity used for storing an item may be marked as available or released only after a period of time or pending archiving of the content item. In addition, known file management techniques (for example file defragmentation) can be used to optimise the utilisation of storage capacity.

In accordance with a further aspect of the present invention there is provided an AV content recording apparatus configured in its operations to perform the method of the invention, the apparatus comprising:
an input arranged to receive a content item;
a store operable to store the content item and to reproduce the content item under the direction of a processor;
a first output arranged to output the reproduced content item;
a second output arranged to output a prompt signal;
a user interface operable to render the prompt signal and to accept user inputs;
a receiver device operable to receive a response from the user interface; and
a processor, a program memory and a data memory all interconnected by means of a bus, the processor being operable under control of a program contained in the program memory to:
   direct the storage of a content item;
   direct the reproduction of the content item for review by a user;
   during reproduction of the stored content item, analyse the content item to identify the occurrence of a pre-determined condition;
   where a pre-determined condition occurs, prompt the user for a response; and
   configure the storage capacity used for storing the content item according to the user response.

Advantageously, such an AV content recording apparatus may interface with legacy product functions such as analogue and digital tuners (for example UHF PAL, DVB-T, DAB, satellite, cable), media players and recorders utilising removable media (for example VHS, DVD, MiniDisc), presentation devices (for example a TV receiver, audio system), remote hard disk storage (for example an external PC or server) and internet connection (for example a dial-up/xDSL modem or a set top box). The interfaces to such products may use any suitable wired (for example Scart, RF, Ethernet, USB) and/or wireless (for example WiFi, Bluetooth, low power radio, infrared) interconnection. Alternatively any of the above functions may be incorporated within the AV content recording apparatus.

An advantage of the present invention is that storage capacity is configured during use rather than as a separate housekeeping task. A prompt is automatically provided to the user which enables him/her to decide whether to delete an item at a time which is convenient and when he/she is best informed. In this way, the utilisation of finite storage capacity is improved by ensuring unwanted content is removed from storage as soon as possible enabling more additional content to be recorded on a speculative and/or scheduled basis than would otherwise be the case. Furthermore, preferably the occurrence of the prompt is timed such that the user takes action before being distracted onto other tasks or activities; and preferably that content is conditionally removed (deleted) such that a user can reverse an earlier decision.

Embodiments of the present invention will now be described, by way of example only, with reference to the accompanying drawings in which:

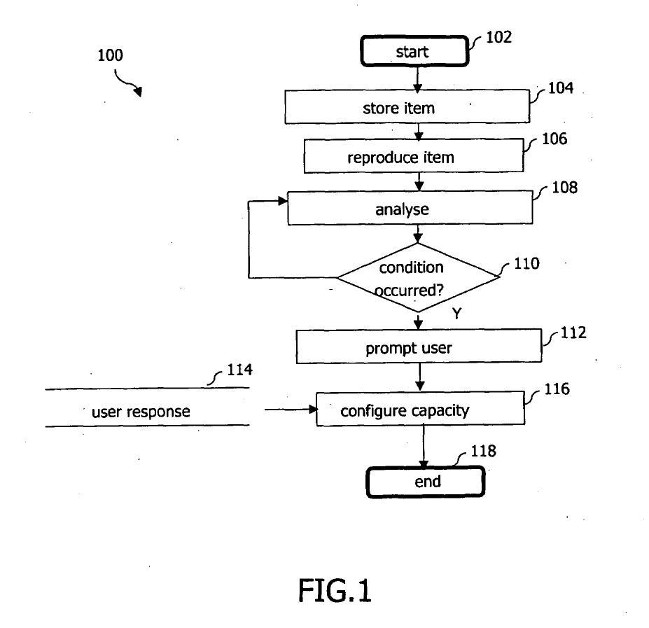

FIG. 1 is a flowchart of a method for configuring the storage capacity of a recording apparatus used for storing at, least one AV content item; and

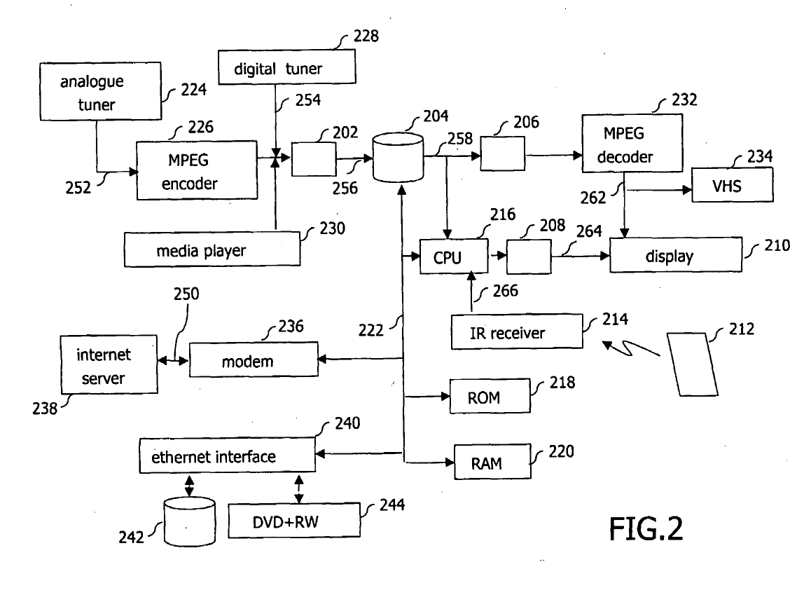

FIG. 2 is a schematic diagram of an AV content recording apparatus.

FIG. 1 shows a flowchart of a method for configuring the storage capacity of a recording apparatus used for storing at least one AV content item. The method, shown generally at 100, starts at 102 and stores 104 a content item. Storage can be on any suitable media including tape, optical/magnetic disk, solid state and the like. Preferably, disk or solid state media are preferred since these typically employ a file management system to allow convenient access to a content item from among a number of stored items; furthermore in the case of video, reproduction of a particular item can be made contemporaneously with its recording. The method then reproduces 106 the stored item for review by a user subsequently (for example in the case of tape storage) or contemporaneously with storing of the item, for example where an item is time shifted by a short time interval. It should be noted that such reproduction may be conditional on being authorised, for example where the stored item is rented; this is discussed in more detail below in relation to FIG. 2. While reproducing the stored content item, the content is analysed 108 to identify the occurrence of a pre-determined condition. Certain conditions are pre-determined, for example to enable an assessment to be made as to utilisation of the reproduced content. In a preferred embodiment identifying a condition occurring at the end of the reproduced content item can be usefully used to trigger an action to be taken in respect of the content item. Alternatively or in addition, a condition comprising the identification of the start and end of the content item can be used to trigger further actions, in this case inferring that the entire item has probably been reviewed. Other conditions can be readily identified by the skilled reader, for example explicitly logging that an item has been entirely reviewed.

A condition can be identified by analysing the content itself. Alternatively or in addition, suitable metadata associated with the content can be interpreted. Where available, the latter is preferred since it provides an explicit indication and also requires less processing. Such metadata may comprise data from Video Programming System (VPS), Programme Delivery Control (PDC) or Electronic Programme Guide (EPG) services. Some implementations of PDC provide metadata identifying the start of each TV show. In an example case where a broadcast TV show is speculatively recorded and contemporaneously reproduced (for example using a PVR), such metadata is able trigger a suitable action, for example metadata corresponding to the start of a following show is identified which in turn causes the user to be prompted. Where no user response is obtained the apparatus decides to maintain (keep in storage) the recorded show. Clearly, due to commercial/promotional advertising and the like, such metadata might only occur several minutes after the speculatively recorded show ended. In some circumstances this is acceptable (for example the user is asleep or otherwise unavailable).

Other situations require more accurate determination of the end of a content item. This is particularly the case when contemplating deletion or archiving of the item. A key reason is that a user may quickly change his/her context (activity) at the end of reviewing an item. Preferably, suitable metadata associated with a content item is provided to enable the end of (and/or points within) an item to be accurately identified. This requires the cooperation of content providers, publishers and broadcasters. Where such metadata is not provided, known methods can be deployed to perform such identification. To accurately identify the end of a video content item without the aid of suitable metadata, a preferred method is to detect the credits present at the end of the item. This allows a timely identification of a condition useful for deleting or archiving the item without the risk that the reviewer has already changed context (for example, has switched to watching another item, gone to make a beverage, etc.).

Once a pre-determined condition has occurred 110, the method then prompts 112 the user (reviewer). Such prompts may take the form of a visual and/or audible signal, and/or other sensory signal. Where the prompt occurs at the end of a content item, an objective is to obtain a decision from the user as to whether to delete or keep the content item that has just ended. Various sub-choices can be offered within either course of action, including, in the case of deletion, the release of capacity after expiration of a pre-determined period of time, or following archiving of the item onto another media. Any practical pre-determined period can be used, for example a few days; preferably the period is determined in advance by the user. It is an objective to remove the item in order to release the storage capacity it occupied for use by other items, such removal being independent of the amount of storage capacity presently available on the storage media. The user may, or may not, provide a response 114 to a prompt. Based on any such response, the method then configures 116 the storage capacity used by the content item to enable the decided action to be taken, examples of which actions have been described above. Typically, configuration of a stored content item may comprise tagging the item file with attribute data describing the status of the item such as the expected release date of the storage capacity occupied by the item, any conditions to be satisfied prior to release of the capacity, etc. The method ends at 118.

FIG. 2 shows a schematic diagram of an AV content recording apparatus. The apparatus comprises an input 202 which receives from a source an AV content item 256 encoded in digital format. For example an MPEG encoder 226 encodes composite analogue video 252 (e.g. PAL, SECAM, NTSC) received via analogue UHF broadcast tuner 224; or a digital tuner 228 such as a DVB or DAB tuner receives signals via terrestrial, cable/broadband or satellite; or a digital media player 230 such as a CD, DVD, MiniDisc—each source providing digital data 254 to input 202. The apparatus also comprises a store 204 which may be a hard disk, removable media (e.g. CD-R, recordable DVD, MiniDisc, Flash memory, tape), or solid state memory. In the example of FIG. 2, a disk based storage is used in which each recorded content item can be identified and its storage capacity selectively released or maintained; one such example is a hard disk drive. A further advantage of storage such as hard disk drive is the ability to optimise the utilisation of storage capacity using file management techniques, for example file defragmentation. The apparatus further comprises a first output 206 used to output a reproduced content item 258, which for example may comprise an MPEG stream which is then decoded by MPEG decoder 232 into an analogue format 262 suitable for rendering on a display 210 or for recording on VHS 234. The apparatus further comprises a second output 208 which outputs a prompt signal 264 provided from CPU processor 216. As shown, the prompt signal 264 is in a format suitable for rendering on display 210, for example as an on-screen icon. Alternatively or in addition, the prompt signal is rendered as an audible or other sensory prompt (not shown in FIG. 2). The apparatus also provides as part of the user interface, a user input device 212 which (as illustrated) is an infrared remote controller but might be a local keypad or other input device. Inputs from user input device 212 are received by IR receiver 214 and communicated 266 to the processor 216. The processor 216 operates under control of a program contained in program memory (such as ROM 218) and data (such as temporary results of computation) contained in a data memory (such as RAM 220); optionally, the data memory could reside in store 204. As shown in the example of FIG. 2, the processor 216, ROM 218, RAM 220 and store 204 are interconnected by means of bus 222. Alternative configurations are readily identifiable to the skilled person, for example a microcontroller with on-chip CPU, ROM and RAM.

In operation, the processor directs storage of a content item received by the apparatus as discussed above. Content items for storing may also be available via bus 222 from other sources such as a network (including the Internet), as discussed below. The processor then directs the store to reproduce the stored content item 258 for review by a user. During reproduction, the content item is analysed by the processor to identify the occurrence of a pre-determined condition. Analysis may be applied to the content item data itself and/or metadata associated with the content item. Where a pre-determined condition occurs, the processor arranges to output a prompt 264 via second output 208 to the user for a response, which response 266 (if any) is received via receiver 214. The processor then arranges to configure the storage capacity used for storing the content item according to the user response, for example by adapting attributes associated with the stored content item file, as discussed earlier. An example is now described where a user has not responded to a prompt: consequently the processor configures the storage capacity used to store the content item to maintain storage of the item for a period of time, such period being pre-determined by the program or user. Subsequently, the processor measures elapsed time using any suitable means available, for example a timer or by reference to received time data (for example data received via a broadcast TV teletext channel such as BBC1 Ceefax). Once the processor has determined the period of time has elapsed, it then adapts one or more attributes associated with the relevant stored content item file to indicate that the capacity used by the item may now be released. The apparatus may also comprise any of the elements such as tuners, media player, VHS recorder, display and so forth, as described above.

As an enhancement, the apparatus comprises a modem 236 connected to bus 222 and used to exchange data 250 with a remote server such as an Internet server 238. In operation, the processor registers the existence of a particular stored content item with the server which then provides authorisation to enable the reproduction of the stored content item. This authorisation may be in return for a supplementary payment; one method is the Internet transaction protocol SSL over TCP/IP. Alternative means of authorisation in place of the modem and server include a Smart card and reader combination, or manual input by the user of an authorisation code, perhaps via user input device 212. Clearly, the connection to an Internet server as described also provides the apparatus with a further channel to receive content item files for storage in store 204 or to send content item files to a server.

For archival or other purposes, a further interface 240 (such as Ethernet) may be connected to bus 222 to exchange data, in particular content item file data, between the apparatus and external storage such as a hard disk 242 (perhaps located in a home PC or network server) and/or removable media using recorder 244 such as a DVD recorder, CD-R or MiniDisc recorder. In this way, stored content items in store 204 may be archived conveniently and quickly to the desired media. Such archiving may be done on a batched basis, for example collating several items marked for archiving onto a single recordable DVD. Suitably, the store 204 might also contain a log of archived items matched to the archive media identity (e.g. recorded DVD disc number). Clearly, such a connection to a network storage or DVD device also provides the apparatus with a further channel to receive content item files for storage in store 204.

The foregoing method and implementation are presented by way of examples only and represent a selection of a range of methods and implementations that can readily be identified by a person skilled in the art to exploit the advantages of the present invention.

In the description above and with reference to FIG. 1, there is provided a method for configuring the storage capacity of a recording apparatus. An AV content item is recorded 104 preferably on a random access media, for example a hard disk based personal video recorder. It is then reproduced 106 for review by a user, possibly contemporaneously with the recording. During reproduction, the content and/or metadata associated with the content is analysed 108 to identify a pre-determined condition. Where a condition occurs 110, the user is prompted 112 for a response. The storage capacity used for storing the content item is then configured 116 according to the user response, including the case where no user response is provided.

1. A method for configuring the storage capacity of a recording apparatus used for storing at least one AV content item, the method comprising:
storing (104) a content item;
reproducing (106) the stored content item for review by a user;
while reproducing the stored content item, analysing (108) the reproduction of the content item to identify the occurrence of a pre-determined condition;
where a pre-determined condition occurs (110), prompting (112) the user for a response; and
configuring (116) the storage capacity used for storing the content item according to the user response.

2. A method as claimed in claim 1 wherein the stored content item is a recording of a live broadcast content item and is reproduced contemporaneously with the live broadcast content item.

3. A method as claimed in claim 1 wherein the pre-determined condition comprises identifying the end of the content item.

4. A method as claimed in claim 3 wherein the content item comprises video and the end of the item is identified by detecting credits present at the end of the item.

5. A method as claimed in claim 3 wherein the pre-determined condition further comprises identifying the start of the content item and the user is prompted when both the start and end of the content item have been identified.

6. A method as claimed in claim 1 wherein the storage capacity used for storing the content item is configured to maintain storage of the content item in the case where there is no user response to the prompt.

7. A method as claimed in claim 6 wherein the stored content item is a recording of a rented content item and a subsequent reproduction of which is conditional on an authorisation.

8. A method as claimed in claim 6 wherein storage is maintained for a pre-determined period of time.

9. A method as claimed in claim 1 wherein configuring the storage capacity is the release of said capacity.

10. A method as claimed in claim 9 wherein the release is conditional on archiving the content item.

11. An AV content recording apparatus, the apparatus comprising:
an input (202) arranged to receive a content item;
a store (204) operable to store the content item and to reproduce the content item under the direction of a processor (216);
a first output (206) arranged to output the reproduced content item;
a second output (208) arranged to output a prompt signal;
a user interface (210, 212) operable to render the prompt signal and to accept user inputs;
a receiver device (214) operable to receive a response from the user interface; and
a processor (216), a program memory (218) and a data memory (220) all interconnected by means of a bus (222), the processor being operable under control of a program contained in the program memory to:
direct the storage of a content item;
direct the reproduction of the content item for review by a user;
during reproduction of the stored content item, analyse the content item to identify the occurrence of a pre-determined condition;
where a pre-determined condition occurs, prompt the user for a response; and
configure the storage capacity used for storing the content item according to the user response.

12. An apparatus as claimed in claim 11 further comprising a tuner (224, 228) operable to provide a content item to the input (202).

13. An apparatus as claimed in claim 11 further comprising a player (230) operable to reproduce a content item from a removable media and provide the item to the input (202).

14. An apparatus as claimed in claim 11 wherein the store comprises a hard disk drive.

15. An apparatus as claimed in claim 11 wherein the store comprises a removable media.

16. An apparatus as claimed in claim 11 wherein the presentation device (210) is a display and the reproduced content item and prompt signal are video signals for rendering on the display.

17. An apparatus as claimed in claim 11 further comprising a first interface (236) operable to communicate with an authorisation device (238).

18. An apparatus as claimed in claim 17 wherein the first interface is a modem (236) for connecting to an Internet server (238) operable to authorise the reproduction of a content item held in store (204).

19. An apparatus as claimed in claim 11 further comprising a second interface (240) operable to communicate with an archiving device (242, 244).

20. An apparatus as claimed in claim 19 wherein the second interface is Ethernet (240) for communicating with a server (242) or removable media recorder (244).

21. (canceled)

22. (canceled)
